(19) United States
(12) Patent Application Publication
(10) Pub. No.: US 2005/0048903 A1
(43) Pub. Date: Mar. 3, 2005

(54) Vent for corrugated wall

(76) Inventor: Kevin McGhie, Fremont, CA (US)

Correspondence Address: JOSHUA D. ISENBERG, 204 CASTRO LANE, FREMONT, CA, 94539, US

(21) Appl. No.: 10/627,412

(22) Filed: Jul. 25, 2003

(51) Int. Cl. B60H 1/00

(52) U.S. Cl. 454/118

(57) ABSTRACT

A vent for a corrugated wall is disclosed. The vent includes a sheet of material bent to form two or more panels such that the vent fits within the corrugations of the corrugated wall. The sheet of material includes one or more openings. Vents of this type are suitable for the installation on the corrugated walls of cargo containers. Such a vent may be installed by cutting a hole in the corrugated wall where the vent is to be installed. It is desirable to make the hole of slightly smaller dimensions than the vent so that the vent at least partly overlaps the wall. The vent is then attached to cover the hole by any suitable method.

### FIELD OF THE INVENTION

The present invention relates to the ventilation of shipping containers. More specifically allowing for the easy installation of such vents that conform to the corrugation of shipping containers.

### BACKGROUND OF THE INVENTION

With the development of the container ship industry, a considerable amount and variety of goods can be transported around the world in cargo containers. Such containers are typically in the shape of rectangular boxes of a standardized size that can be stacked on a container ship and transferred to or from a railroad flatcar or tractor-trailer. Such cargo containers allow transshipment of the goods within the container without having to unload it as it travels from road to rail to ship. Cargo containers are often used to store and ship personal belongings. Such containers often require ventilation in order to protect the goods stored within from the effects of heat or moisture. In addition, cargo containers are often used as structures, buildings and even dwellings that require ventilation. Unfortunately such cargo containers are typically manufactured without a suitable opening for ventilation. In the prior art, cargo containers were ventilated by installing conventional foundation vents on one or more of the container walls.

Foundation vents are designed to be built into the foundation walls of a home or other building to provide reliable and regular crawl space ventilation. While foundation vents are available in a wide variety of designs, in general they include a frame that is securable within an opening in the foundation wall. Typically, the frame is rectangular in shape and is conveniently sized to fit within the space in the foundation wall. The vent supports a grill structure (wire mesh), which allows airflow through the vent, but deters entry by mice other small varmints, and insects such as roaches. These vents are often provided to insure a minimal flow of air through a building (structure) The minimal flow of air reduces mildewing, and allows for the escape of hot air within the structure.

Unfortunately, foundation vents are designed for installation in foundations. Shipping containers when used as structures or as framing for buildings are not designed for use with “conventional” foundation vents.

In the prior art when shipping containers are modified with vents, traditional foundation vents are used. Because a shipping container uses corrugated steel in the design it is difficult to install them. A steel frame must be constructed with angle iron so that it will fit into the corrugation. Then the foundation vent is attached to the frame and both are installed into the container. This proves to be time consuming and not cost effective. Furthermore, the foundation vents tend to protrude beyond the corrugations of the container wall. Such protrusions render the container unusable for shipment on a container ship since they cannot be stacked properly.

Clearly there exists a need for a vent that meets the pre-imposed requirements of structural integrity and pest impenetrability Such a vent also should economical to produce and easy to install.

### BRIEF DESCRIPTION OF THE DRAWINGS

The teachings of the present invention can be readily understood by considering the following detailed description in conjunction with the accompanying drawings, in which:

FIG. 1 is a perspective diagram of a ventilator according to an embodiment of the present invention;

FIG. 2A is an elevation view of a portion of a corrugated wall of a cargo container having a vent of the type shown in FIG. 1 attached thereto;

FIG. 2B is a cross section taken along line B-B of FIG. 2A

FIG. 2C is a cross-sectional view of a portion of a corrugated wall having an alternative vent according to an embodiment of the invention attached thereto;

FIG. 2D is a cross-sectional view of a portion of an alternative corrugated wall having another alternative vent according to an embodiment of the invention attached thereto; and

FIG. 2E is a cross-sectional view of a portion of another alternative vent according to an embodiment of the present invention.

FIG. 3 is an isometric diagram of a cargo container according to an embodiment of the present invention.

### DESCRIPTION OF THE SPECIFIC EMBODIMENTS

Although the following detailed description contains many specific details for the purposes of illustration, anyone of ordinary skill in the art will appreciate that many variations and alterations to the following details are within the scope of the invention. Accordingly, the exemplary embodiments of the invention described below are set forth without any loss of generality to, and without imposing limitations upon, the claimed invention.

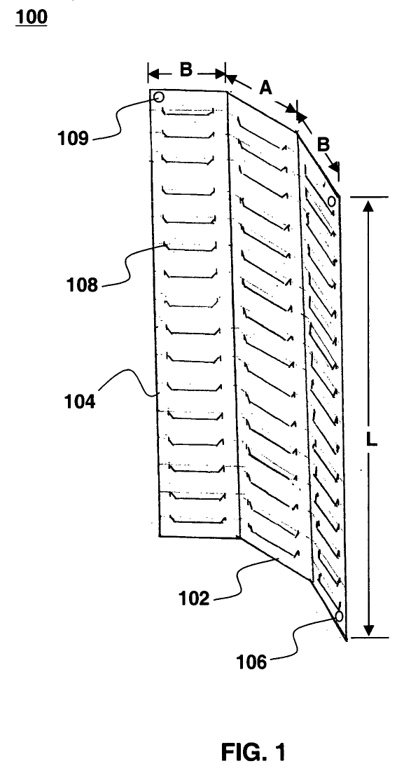

Embodiments of the present invention include vents for corrugated walls, such as those found on cargo containers, corrugated metal buildings, and the like. Such a vent may include a sheet of material bent to form two or more panels such that the vent fits within the corrugations wall, wherein the sheet of material includes one or more openings. FIG. 1 depicts an example of a vent 100 for a corrugated wall. The vent 100 generally includes a sheet of material bent to form two or more panels. The embodiment depicted in FIG. 1 is a vent 100 that uses three panels including a central panel 102 of width A disposed between outer panels 104, 106, each of width B. At least one of the panels includes openings 108 that provide sufficient open area to allow for ventilation. In the example shown in FIG. 1, the openings 108 are in the form of louvers. The louvers may be arranged as shown in FIG. 1 with each panel having a row of louvers, with space between adjacent rows of louvers to allow for bending of the sheet of material into the panels. The louvers may be uniformly sized and spaced or they may be of different sizes or spacing. Alternatively, they may be arranged in a chevron pattern or other pattern. The vent 100 may include holes 109 in on or more of the panels to facilitate attachment of the vent to a corrugated wall, e.g., by fasteners such as rivets, sheet metal screws and the like.

The panels 102, 104, 106 are bent with respect to each other such that they conform to the corrugations in the corrugated wall. The sheet of material from which the vent 100 is made may be metal (e.g., ferrous or non ferrous), fiberglass, vinyl or plastic and may be of any suitable thickness, e.g., 10-gauge to 30-gauge thickness. In a preferred embodiment, the material is 20-gauge galvanized steel. By comparison, a typical corrugated wall for a cargo container is e.g., 14-gauge steel. The openings 108 may be formed by any suitable method, e.g., punching, drilling, etc. By way of example, louvers may be formed by a standard punch and die method well known in the sheet metal working art. A screen (not shown) having screen openings smaller than the openings in the vent may optionally be attached to the sheet of material (on either side) such that the screen covers all or a portion of the openings in the vent. Alternatively, the screen may be attached to one side of the wall and the vent may be attached to the other. The screen may have a frame that finishes the opening in the wall.

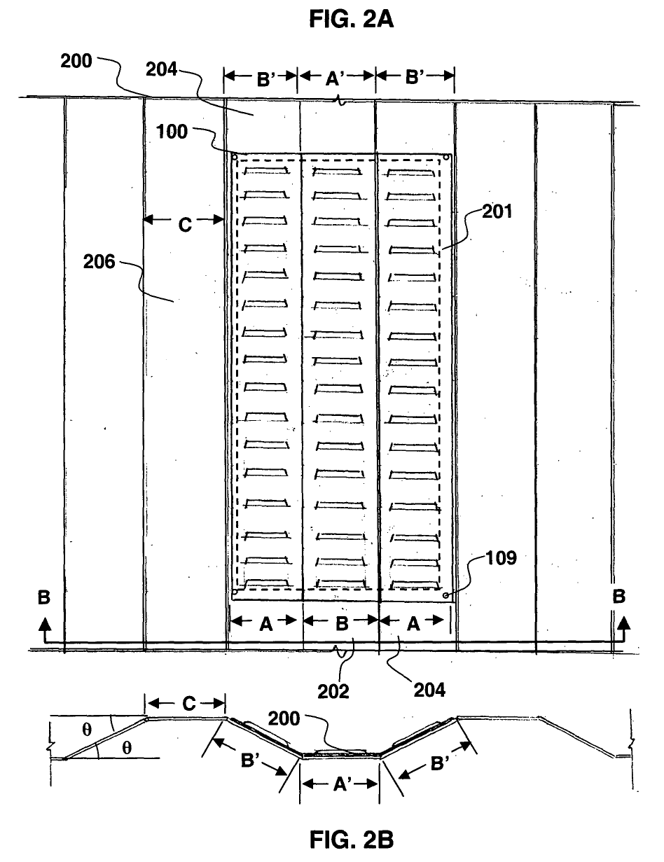

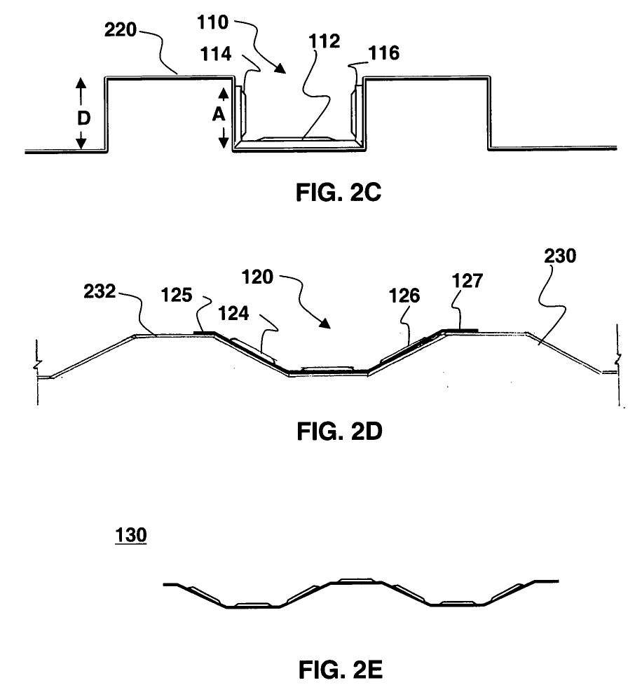

The panels 102, 104, 106 may be substantially rectangular in shape with each panel having a length and width. In other embodiments they may have other shapes. The panels 102, 104, 106 may be made to any suitable length L. In one particularly advantageous embodiment, the vent may be made to a length L of roughly eight feet and may be cut into individual sections of lesser length for installation on one or more containers. Although the panels are shown as being of the same length, they may be of different lengths. The angle of bend between the central panel 102 and either of the outer two panels 104, 106 is selected to match the standard corrugations on a cargo container wall. By way of the example shown in FIG. 2A, a container wall may have a corrugation pattern with valley portions 202 of width A′, slanted portions 204 of width B′, and peak portions 206 of width C.

Although three panels are shown in FIG. 1, for the sake of example, the invention is not limited to this particular configuration. Embodiments of the invention include vents having only two panels or more than three panels are within the scope of the present invention. For example, a vent may have multiple panels that conform to any number of multiple corrugations in a corrugated wall. FIG. 2E shows an example of a vent 130 having multiple panels configured so that the vent may cover multiple wall corrugations.

By way of numerical example A′, B′ and C may respectively be 72 mm, 77 mm and 70 mm. Based on these dimensions, the angle θ between the slanted portions and the peak or valley portions is be about 28°. Once the dimensions and angles of the corrugation on the container wall are known, the sheet of material may be bent such that the panels conform to the container wall, e.g., using a standard breaker or other sheet metal bending machine. For louver vents, it is desirable to form the louvers first and then bend the sheet of material to form the panels.

Referring to FIGS. 2A and 2B, the panels on the vent 100 may be sized such that the vent, when installed, does not protruded beyond an outside surface of the corrugations on a corrugated wall 200. For example, where the corrugations of the wall have slanted portions 202 of width A′, the outer panels may have a slightly lesser width A such that they do not protrude beyond the outer surface of the container wall, i.e., beyond the peaks as shown in FIG. 2A. Such a configuration is advantageous for cargo containers that must be closely stacked, as on a container ship. The vent 100 is shown covering a hole 201 in the wall 200. By way of numerical example, the vent 100 may fit in the corrugations of the wall 200 having the above described dimensions if the width A of the central panel 102 is about 71 mm and the width B of the outer panels 104, 106 is about 73 mm and the outer panels 104, 106 are each bent at an angle of about 28° with respect to the central panel. The vent 100 may be weather sealed to the corrugated wall 200 e.g., using a caulk or other sealant.

Embodiments of the present invention are not limited by the angle of bend between the panels. In principle this angle can be any angle greater than 0° up to 90°. Referring to FIG. 2C, an alternative embodiment of the present invention includes a vent 110 that conforms to a corrugated wall 220 having rectangular or nearly rectangular corrugations. Such corrugated walls are often used as the end wall of a cargo container. Again, the vent 110 may have a central panel 112 and outer panels 114, 116 with the outer panels being of a lesser width A than a depth D of the corrugations in the wall. Alternatively, the outer panels 114, 116 may have width A that greater than or equal to the depth D of the wall corrugations.

Referring to FIG. 2D, another alternative embodiment of the present invention includes a vent 120 having a central portion 122 disposed between first and second slanted portions 124, 126, and side wings 125, 127 that extend beyond each of the slanted portions 124, 126. The side wings 125, 127 overlap part of the peaks 232 in a corrugated wall 230. Such a configuration is advantageous in that it facilitates attachment of the vent to the wall 230, e.g., by rivets, welding, taping, or the like. Note that such a vent may be bent to conform to a wall having substantially rectangular corrugations, e.g., as shown in FIG. 2C.

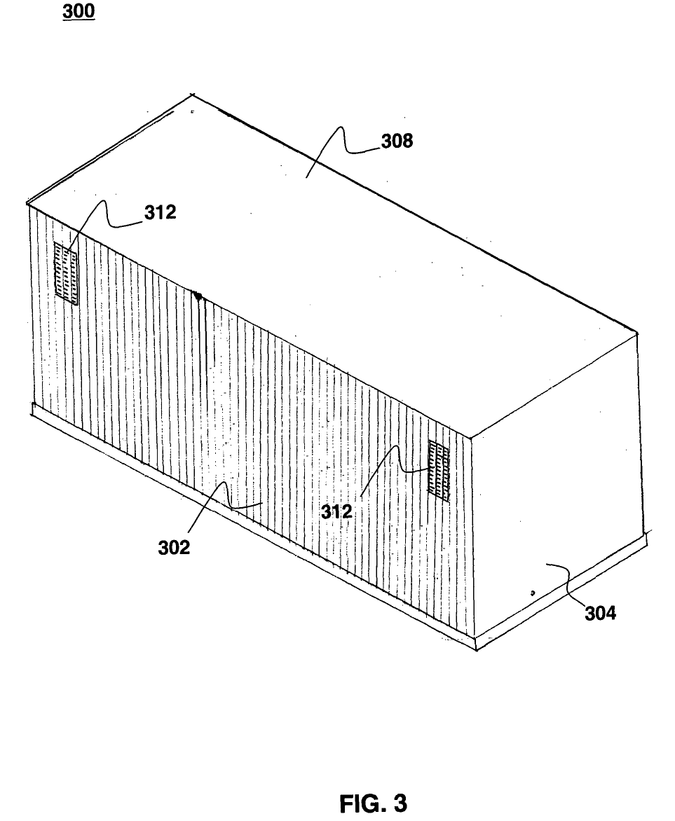

FIG. 3 depicts an example of a cargo container 300 with corrugated walls having a vent installed in one of the walls according to another embodiment of the present invention. The cargo container 300, also referred to as a dry van, shipping container, typically includes two side walls 302, an end wall 304 a floor 306, and a roof 308 arranged in a substantially box-like configuration. By way of example, the container 300 may be between about 20 feet and about 53 feet in length. Standard lengths include, e.g., 24, 45, 48 and 53 feet. The container 300 may be between about 6 feet and about 9 feet 6 inches in height. Typical standard heights include 8 feet, 8 feet 6 inches, and 9 feet 6 inches. One or more of the walls 302, 304 may include an optional door. At least one of the walls includes one or more corrugations.

One or more vents 312 of any of the types described above are attached to the wall having the corrugations. If desired, more than one vent may be attached to more than one wall. The cargo container may be any type commonly used for carrying cargo. Alternatively, the cargo container 300 may be one that has been converted for use as a dwelling or other building.

Installation of a vent of the types described herein is fairly straightforward. First a hole is cut in the corrugated wall where the vent is to be installed. It is desirable to make the hole of slightly smaller dimensions than the vent so that the vent at least partly overlaps the corrugated wall. The vent is then attached to cover the hole by any suitable method such as riveting, welding, taping, sheet metal screws, gluing, or equivalents. A sealant, such as a caulk or the like may be used to seal the vent to the corrugated wall before and/or after attachment to the wall to make a weather tight seal. In addition, the edges of the hole may optionally be ground smooth prior to attaching the vent. A screen may be optionally attached to the vent or the hole to keep out insects. By way of example, the screen may be attached to a thin frame made of a material that can be bent to conform to the corrugations. The screen may then cover the hole from one side of the wall and the vent may cover the hole from the opposite side of the wall. Both the vent and screen may be attached to the wall using fasteners, such as rivets that penetrate the vent, the wall, and the frame surrounding the screen.

While the above is a complete description of the preferred embodiment of the present invention, it is possible to use various alternatives, modifications and equivalents. Therefore, the scope of the present invention should be determined not with reference to the above description but should, instead, be determined with reference to the appended claims, along with their full scope of equivalents. The appended claims are not to be interpreted as including means-plus-function limitations, unless such a limitation is explicitly recited in a given claim using the phrase “means for.”

1. A vent for a corrugated wall, comprising:
a sheet of material bent to form two or more panels such that the vent fits within the corrugations of the corrugated wall, wherein the sheet of material includes one or more openings.

2. The vent of claim 1 wherein the one or more of the panels is substantially rectangular in shape.

3. The vent of claim 1, wherein the sheet of material is made from a ferrous or non-ferrous metal, fiberglass, vinyl, or plastic material.

4. The vent of claim 1 wherein the two or more panels are sized such that no portion of the vent protrudes beyond an outer surface of the corrugated wall.

5. The vent of claim 1 further comprising a screen having screen openings smaller than the one or more openings in the vent attached to the sheet of material such that the screen covers the openings in the vent.

6. The vent of claim 1 wherein the one or more openings include a plurality of louvers.

7. The vent of claim 6 wherein the louvers are arranged in a chevron pattern on one or more of the panels.

8. The vent of claim 1 wherein the two or more panels include a central panel disposed between two outer panels.

9. The vent of claim 8 wherein each of the two or more outer panels is bent at an angle of greater than 0° and up to about 90° with respect to the inner panel.

10. The vent of claim 9 wherein each of the two or more outer panels is bent at an angle of about 28° with respect to the inner panel.

11. The vent of claim 8 wherein each of the outer panels has a length that is slightly less than a length of corresponding slanted portions of a corrugated wall to which the vent is to be attached.

12. The vent of claim 8 wherein each of the outer panels is bent at approximately a right angle with respect to the central portion.

13. The vent of claim 8 further comprising first and second side wings, each side wing being respectively attached to one of the outer panels.

14. The vent of claim 8 wherein the side wings are bent at an angle with respect to the outer panels such that the side wings overlap a peak portion of a corrugated wall to which the vent is to be attached.

15. The vent of claim 14 wherein the side wings are bent at approximately a right angle with respect to the outer panels and the outer panels are bent at approximately right angles with respect to the central panel.

16. The vent of claim 8 further comprising additional panels so that the vent may cover multiple corrugations in the corrugated wall.

17. A method for ventilating a corrugated cargo container, the method comprising:
forming a hole in a wall of the cargo container;
covering the hole with a sheet of material bent to form two or more panels such that the vent fits within the corrugations of the cargo container, wherein the sheet of material includes one or more openings.

18. The method of claim 17 further comprising attaching a screen to the panels, wherein the screen covers the openings.

19. The method of claim 17 wherein the hole has slightly smaller dimensions than the dimensions of the vent so that the vent at least partially overlaps the corrugated wall.

20. The method of claim 17 wherein the vent is attached to the corrugated wall by riveting, welding, taping, sheet metal screws, or gluing.

21. The method of claim 17, further comprising sealing the vent to the corrugated wall.

22. The method of claim 17 further comprising covering the hole with a screen having screen openings that are smaller than the openings in the vent.

23. The method of claim 22 wherein the screen includes a frame made of a material that can be bent to conform to the corrugations of the wall.

24. The method of claim 23 wherein the screen is attached to one side of the corrugated wall and the vent is attached to the other side of the corrugated wall.

25. The method of claim 23 wherein the vent and the screen are attached to the wall using fasteners that penetrate the vent, the wall, and the frame.

26. A cargo container, comprising:
three or more walls, a floor and a roof arranged in a substantially box-like configuration, wherein at least one of the walls includes one or more corrugations; and
one or more vents attached to the wall having the corrugations, wherein the vent includes a sheet of material bent to form two or more panels such that the vent fits within the corrugations of the cargo container, wherein the sheet of material includes one or more openings.

27. The cargo container of claim 26 wherein the two or more panels are sized such that no portion of the vent protrudes beyond an outer surface of the corrugated wall.

28. The cargo container of claim 26 wherein the vent includes a screen having screen openings smaller than the one or more openings in the vent, the screen being attached to the sheet of material such that the screen covers the openings in the vent.

29. The cargo container of claim 28 wherein the screen is attached to one side of the corrugated wall and the vent is attached to the other side of the corrugated wall.
